(19) United States
(12) Patent Application Publication
(10) Pub. No.: US 2015/0192251 A1
(43) Pub. Date: Jul. 9, 2015

(54) HIGH PRESSURE CARBON COMPOSITE PRESSURE VESSEL

(71) Applicant: Composite Technology Development, Inc., Lafayette, CO (US)

(72) Inventors: Michael Tupper, Lafayette, CO (US); Paul Fabian, Broomfield, CO (US); Kaushik Mallick, Thornton, CO (US); Jacob Barker, Westminster, CO (US); Andrea Haight, Lafayette, CO (US)

(21) Appl. No.: 14/591,785

(22) Filed: Jan. 7, 2015

Related U.S. Application Data
(63) Continuation of application No. 61/924,490, filed on Jan. 7, 2014.

(51) Int. Cl. F17C 13/00; B29C 70/30; B65D 25/14

(52) U.S. Cl. CPC F17C 13/002; B65D 25/14; B29C 70/30; F17C 2203/0663; F17C 2209/2163; B29L 2031/712

(57) ABSTRACT

Embodiments described herein include a composite pressure vessel that includes both high performance fibers and low performance fibers. Embodiments also include a method forming a pressure vessel with high performance fibers and low performance fibers. A plurality of the high performance fibers may be found in an inner layer of the pressure vessel and a plurality of the low performance fibers may be found in an outer layer of the pressure vessel.

### SUMMARY

Embodiments of the invention include a pressure vessel comprising a first composite layer surrounding an inner cavity and comprising a plurality of high performance fibers. The pressure vessel may include a second composite layer disposed on the first composite layer and comprising a plurality low performance fibers. In some embodiments, the plurality of high performance fibers may have a strain greater than 2.0% and the plurality of low performance fibers may have a strain less than 2.0%.

In some embodiments, the low performance fibers may include a textile-PAN precursor fiber or a polyolefin precursor fiber. In some embodiments, the pressure vessel may be capable of storing gases or liquids at pressures above 700 bar. In some embodiments, the plurality of high performance fibers may include more than 50% of a total amount of fibers by weight or volume comprising the plurality of high performance fibers and the plurality of low performance fibers.

In some embodiments, a pressure vessel may include a first composite layer surrounding an inner cavity and a plurality of high performance fibers; and a second composite layer disposed on the first composite layer and comprising a plurality low performance fibers. The plurality low performance fibers may include fibers that are different than the plurality of high performance fibers, and wherein the plurality of low performance fibers have at least one measurable characteristic that is less than at least one measurable characteristic of the plurality of high performance fibers.

In some embodiments, the plurality of high performance fibers may have a longitudinal strain between 0.8% and 2.0%, and the plurality of low performance fibers have a longitudinal strain less than the high performance fibers.

In some embodiments, the low performance fibers may include a textile-PAN precursor fiber or a polyolefin precursor fiber. In some embodiments, the pressure vessel may be capable of storing gases or liquids at pressures above 700 bar.

In some embodiments, the plurality of high performance fibers may include more than 50% (by weight or volume) of a total amount of fibers comprising the plurality of high performance fibers and the plurality of low performance fibers.

In some embodiments, the plurality of high performance fibers may have a strain greater than 2.0% and the plurality of low performance fibers may have a strain less than 2.0%.

In some embodiments, the plurality of high performance fibers may include hoop plies and the plurality of low performance fibers may include helical plies.

In some embodiments, the first composite layer may include a plurality of low performance fibers. In some embodiments, the second composite layer may include a plurality of high performance fibers.

In some embodiments, the pressure vessel may include a third composite layer disposed on the second composite layer and comprising a plurality lower performance fibers, wherein the plurality of lower performance fibers comprise fibers that are different than the plurality of low performance fibers, and wherein the plurality of lower performance fibers have at least one measurable characteristic that is less than at least one measurable characteristic of the plurality of low performance fibers.

Some embodiments may include a method that includes forming a vessel liner on a mandrel; applying a plurality of high performance fibers on the vessel liner; and applying a plurality of low performance fibers on the plurality of high performance fibers. For example, the plurality of low performance fibers comprise fibers that are different than the plurality of high performance fibers, and wherein the plurality of low performance fibers have at least one measurable characteristic that is less than at least one measurable characteristic of the plurality of high performance fibers.

In some embodiments, the plurality of high performance fibers may have a longitudinal strain between 0.8% and 2.0%, and the plurality of low performance fibers have a longitudinal strain less than the high performance fibers.

In some embodiments, the low performance fibers comprise a textile-PAN precursor fiber or a polyolefin precursor fiber.

In some embodiments, the plurality of high performance fibers may include more than 50% (by weight or volume) of a total amount of fibers comprising the plurality of high performance fibers and the plurality of low performance fibers.

In some embodiments, the plurality of high performance fibers have a strain greater than 2.0% and the plurality of low performance fibers have a strain less than 2.0%.

In some embodiments, at least a subset of the plurality of high performance fibers are applied as hoop plies and at least a subset of the plurality of low performance fibers are applied as helical plies.

The method may also include applying a plurality of lower performance fibers on the plurality of low performance fibers, wherein the plurality of lower performance fibers comprise fibers that are different than the plurality of low performance fibers, and wherein the plurality of lower performance fibers have at least one measurable characteristic that is less than at least one measurable characteristic of the plurality of low performance fibers.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 illustrates a cutaway view of an example of a pressure vessel 100 according to some embodiments described herein.

FIG. 2 is a graph showing an example of the hoop strain profile of fibers making up the layers of the wall of the pressure vessel.

FIG. 3A shows the general structure of a cylindrical pressure vessel with interspersed layers of circumferential hoop plies and helical plies according to some embodiments described herein.

FIG. 3B shows a hoop ply sandwiched between two helical plies, allowing with plies having nearly orthogonal fiber orientation according to some embodiments described herein.

FIG. 4 shows a structure for a pressure vessel in accordance with some embodiments.

FIG. 5 is a flowchart of an example process for forming a composite pressure vessel according to some embodiments described herein.

### DETAILED DESCRIPTION

A composite pressure vessel is disclosed that includes both high performance fibers and low performance fibers. A method is also disclosed for creating a pressure vessel with high performance and low performance fibers.

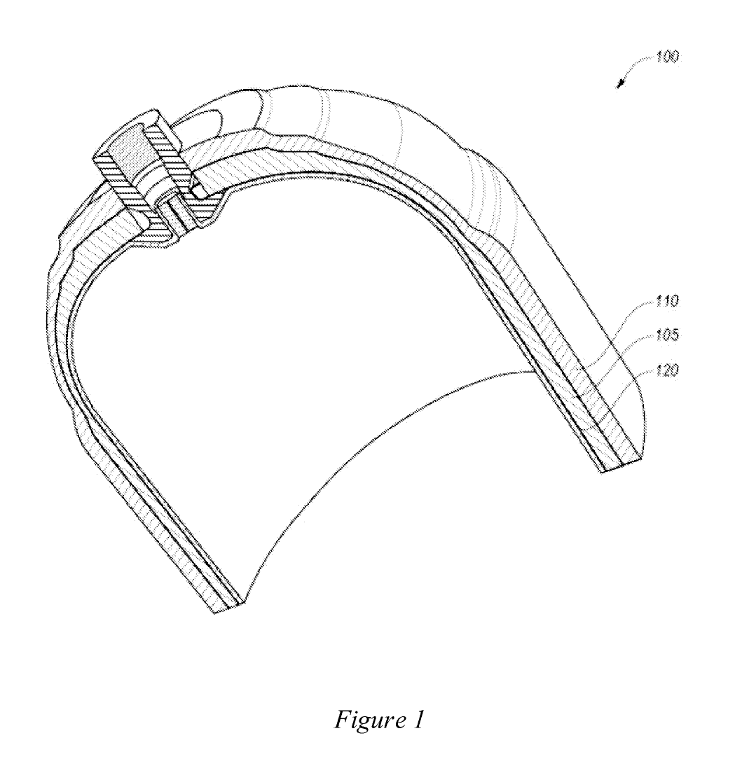

FIG. 1 illustrates a cutaway view of an example of a pressure vessel 100 with a wall that includes a liner 120, an inner layer 105, and an outer layer 110. Each layer may include multiple plies that may include, for example, helically and/or hoop wound fibers. In some embodiments, the performance of the layers may decrease from the inner layer 105 to the outer layer 110. In some embodiments, two, three or more layers may be included in the tank, with each layer being constructed from plies having different performance characteristics relative to the other layers.

In some embodiments, the pressure vessel 100 may be a thick walled vessel, for example, the ratio of the radius over the thickness (R/t) may be 20, 15, 10, or less. For example, for a tank with an R/t ratio of 20, a 20-inch diameter cylindrical tank may have a minimum wall thickness of 1 inch; and for tanks with diameters of 15, 10, 5 inch diameters, the minimum wall thickness may be 0.75, 0.5, and 0.25 inches respectively.

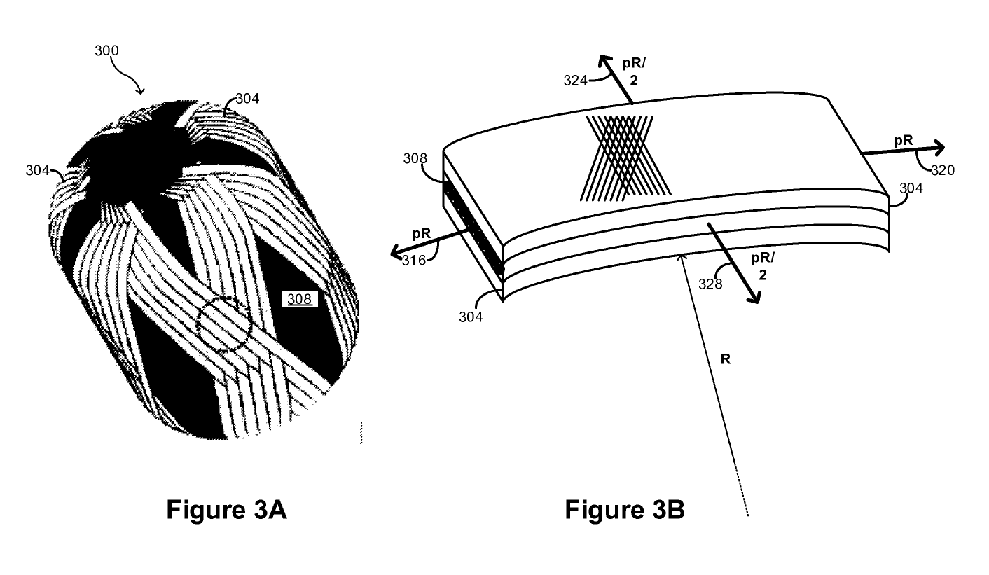

The wall of pressure vessel 100, the inner layer 105, the outer layer 110, or some combination thereof may comprise a number of plies of composite materials such as, for example, 6, 10, 20, 25, 30, 35, 40, 45, 50, 55, 60, 65, 70, 75, 80 plies of composite materials. Some percentage of these plies may be wrapped in a helical pattern while others may be wrapped in a hoop pattern (e.g., see FIG. 3B). The helical and hoop wrapped plies may be interspersed as alternating plies and/or as a finite number of helical plies interspersed by a finite number of hoop plies. For example, two helical plies may be interspersed with 3 hoop plies. The relative number of helical and hoop plies interspersed can vary from a ratio of 1 to 10 to 10 to 1 including any number in between. Furthermore, this ratio of interspersed helical to hoop plies may vary through the thickness of the pressure vessel. For example, the inner plies may have a 10 to 1 ratio, while the outer plies may be a 1 to 10 ratio of helical to hoop plies respectively. These composite materials may include any type of continuous fiber (e.g., carbon fibers), non-continuous fiber, particulates (ranging from nanometer scale to the micrometer scale), and/or one or more matrix materials (e.g., resin, epoxy, etc.).

The composite can consist of multiple different continuous fibers, non-continuous fibers, particulates, and/or matrix materials (e.g., nano materials and/or additions). Individual plies, even within the inner layer 105, the outer layer 110, etc. may include multiple different composite material constituents. For example, within a given layer, helical plies may be made with one type of continuous fiber while the hoop plies may be made with a second type of continuous fiber. Similarly, the matrix material may be different for the different layers as well as for helical and hoop plies.

In some embodiments, the outer layer 110 may include low performance fibers. And, the inner layer 105 may include high performance fibers. In some embodiments, any number of layers may be disposed between the inner layer 105 and the outer layer 110.

In some embodiments, the majority of the fibers within the outer layer may be low performance fibers, and the majority of the fibers within the inner layer may be high performance fibers.

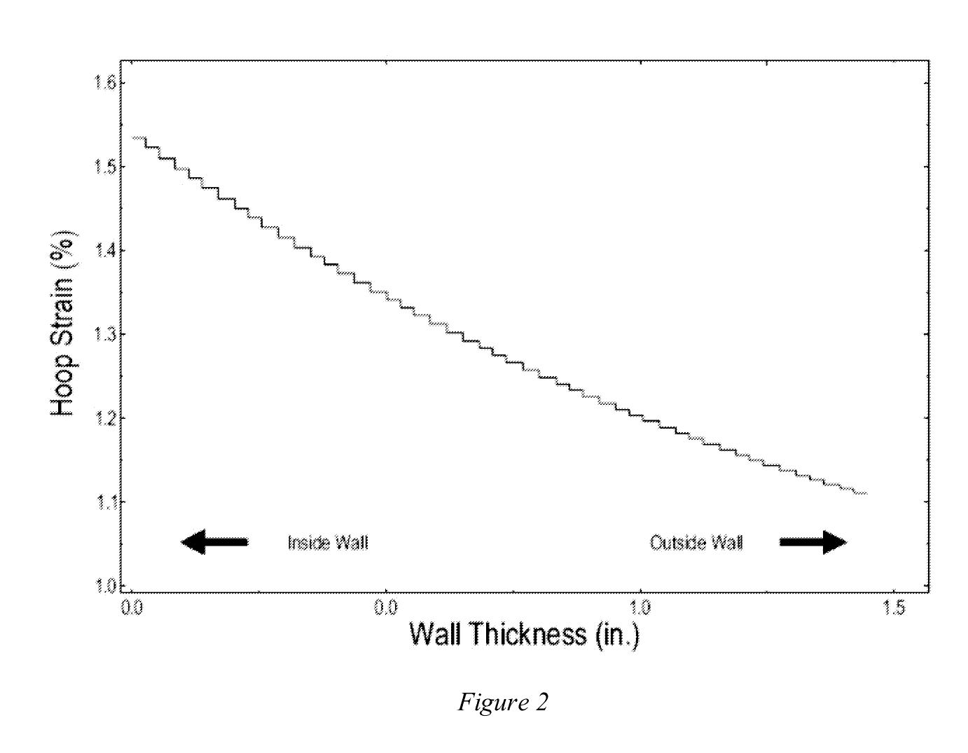

In some embodiments, the wall of the pressure vessel 100 may include layers with fibers that have a performance that decreases from inner layers having higher performance fibers to outer layers having low performance layers. For example, one or more middle layers may include fibers that have a performance that is less than the performance of fibers within the inner layer 105 and greater than the performance of the outer layer 110. In some embodiments a performance profile of the fibers may vary roughly in accordance with the relative position of the layer. As shown in FIG. 2, For example, there may be a fiber performance gradient that decreases from the inner layer to the outer layer.

Additionally or alternatively, FIG. 2 is a graph showing an example of the strain profile of the fibers making up the layers of a wall of a thick walled pressure vessel. The more inner layers may have a higher strain performance than the outer layers. In some embodiments, the inner layer may include more high performance fibers compared with the outer layers.

The high performance fibers, for example, may include fibers that are aerospace grade fibers, and low performance fibers may include fibers that are industrial grade fibers. High performance fibers, for example, may have a rated higher strain capability than low performance fibers. High performance fibers, for example, may have higher strain and/or strength than low performance fibers.

In some embodiments, the modulus of high performance fibers and low performance fibers may be relatively similar such as, for example, within ±5% or ±10%. This may, for example, ensure suitable load sharing between different composite plies and layers.

In some embodiments, high performance fibers may have a higher longitudinal strain than low performance fibers. For example, high performance fibers may have a longitudinal strain that is greater than 1.3% and low performance fibers may have a longitudinal strain that is less than 1.3%. As another example, high performance fibers may have a longitudinal strain that is greater than 1.4% and low performance fibers may have a longitudinal strain that is less than 1.4%. As another example, high performance fibers may have a longitudinal strain that is greater than 1.5% and low performance fibers may have a longitudinal strain that is less than 1.5%. As another example, high performance fibers may have a longitudinal strain that is greater than 1.6% and low performance fibers may have a longitudinal strain that is less than 1.6%. Any measure of longitudinal strain may be used to differentiate high performance fibers and low performance fibers so long as the high performance fibers have a greater strain than the low performance fibers. Moreover, in some embodiments, a high performance fiber may have longitudinal strain between 0.8% and 3.0%, and the low performance fiber may have a longitudinal strain that is less than the high performance fiber.

In some embodiments, the high performance fiber may have a strain (elongation) greater than 1.7%, 1.8%, 1.9%, 2.0%, 2.1%, 2.2%, 2.3%, or 2.4%. The low performance fiber may have a strain below the strain of the high performance fiber. The strain, for example, may be a listed (e.g., on a data sheet) or a tested strain.

In some embodiments, the low performance fiber may have a strain (elongation) less than 1.7%, 1.8%, 1.9%, 2.0%, 2.1%, 2.2%, 2.3%, or 2.4%. The high performance fiber may have a strain above the strain of the low performance fiber. The strain, for example, may be a listed (e.g., on a data sheet) or a tested strain.

The strain of a fiber may be based on any type of measurement of strain such as, for example, strain under load, resting strain, failure strain, rated strain, fiber elongation, etc.

In some embodiments, the high performance fiber may have a tensile strength greater than 500 Ksi, 600 Ksi, 700 Ksi, or 800 Ksi. The low performance fiber may have a tensile strength below the tensile strength of the high performance fiber. The tensile strength, for example, may be a listed (e.g., on a data sheet) or a tested tensile strength.

In some embodiments, the low performance fiber may have a tensile strength less than 500 Ksi, 600 Ksi, 700 Ksi, or 800 Ksi. The high performance fiber may have a tensile strength above the tensile strength of the low performance fiber. The tensile strength, for example, may be a listed (e.g., on a data sheet) or a tested tensile strength.

In some embodiments, the high performance fiber may have a tensile modulus greater than 32 Msi, 33 Msi, 34 Msi, 35 Msi, or 36 Msi. The low performance fiber may have a tensile modulus below the tensile modulus of the high performance fiber. The tensile modulus, for example, may be a listed (e.g., on a data sheet) or a tested tensile modulus.

In some embodiments, the low performance fiber may have a tensile modulus less than 32 Msi, 33 Msi, 34 Msi, 35 Msi, or 36 Msi. The high performance fiber may have a tensile modulus above the tensile modulus of the low performance fiber.

In some embodiments, the tensile modulus may be relatively similar such as, for example, within ±5% or ±10%. The tensile modulus, for example, may be a listed (e.g., on a data sheet) or a tested tensile modulus.

A low performance fiber, for example, may include textile-PAN precursor fiber or a polyolefin precursor fiber or fibers with similar characteristics. A low performance fiber, for example, may include PAN-VA fiber, PAN-MA fiber, Panex 35 fiber, and/or SGL's Sigrafil C carbon fiber or fibers with similar characteristics. A low performance fiber may also include a lignin based fiber or that based on a lignin-PAN blend. A high performance fiber, for example, may include a Toray T700S fiber or a fiber with similar characteristics. A high performance fiber, for example, may include Toray T700S, T800S T1000G, M30 fiber, Hexell AS4, IM7, IM8, IM9, or IM10 fiber, and/or carbon fiber or fibers with similar characteristics. In some embodiments layers may include multiple and/or different high performance fibers or multiple and/or different low performance fibers. Any type of fiber may be used for the high performance fibers and for the low performance fibers without limitation.

In some embodiments, the low performance fibers may account for 40%, 45%, 50%, 55%, or 60% (by weight or volume) of the total fibers comprising the low performance fibers and the high performance fibers. In some embodiments, the high performance fibers may account for 40%, 45%, 50%, 55%, or 60% (by weight or volume) of the total fibers comprising the low performance fibers and the high performance fibers.

In some embodiments, the low performance fibers and/or the high performance fibers may be woven or braided in any number of ways. A weave or braid, for example, may be formed by the diagonal intersection of fibers. A weave or braid, for example, may be formed with three or more fibers intertwined in such a way that no two fibers are twisted around one another.

In some embodiments, the pressure vessel 100 may be capable of storing gases or liquids at pressures above 300, 350, 400, 500, 600, 700, 800, 900 or 1,000 bar.

In some embodiments, the pressure vessel 100 may have a diameter of 5, 10, 15, 20, 25, 30 inches or more. In some embodiments, the pressure vessel 100 may be a type III, type IV, or type V (linerless, all composite) pressure vessel. It is also possible that the tank could operate at cryogenic temperatures, which may include temperatures ranging from −253° C. up to 150° C.

In some embodiments, the outer fibers may experience strain levels that are 20-30% less than that of the inner fibers, for example, at incipient burst failure.

In some embodiments, the pressure vessel 100 may have an inner cavity having a volume of about ranging from 2 to 5000 liters.

In some embodiments, either or both the fibers of the inner layer and/or the fibers of the outer layer may include carbon or may be carbon fibers. Other fibers may also be used such as, for example: glass, Kevlar, Spectra, and others. In some embodiments multiple fibers can be used within a single ply, such as carbon fiber and glass fiber mixed in one ply.

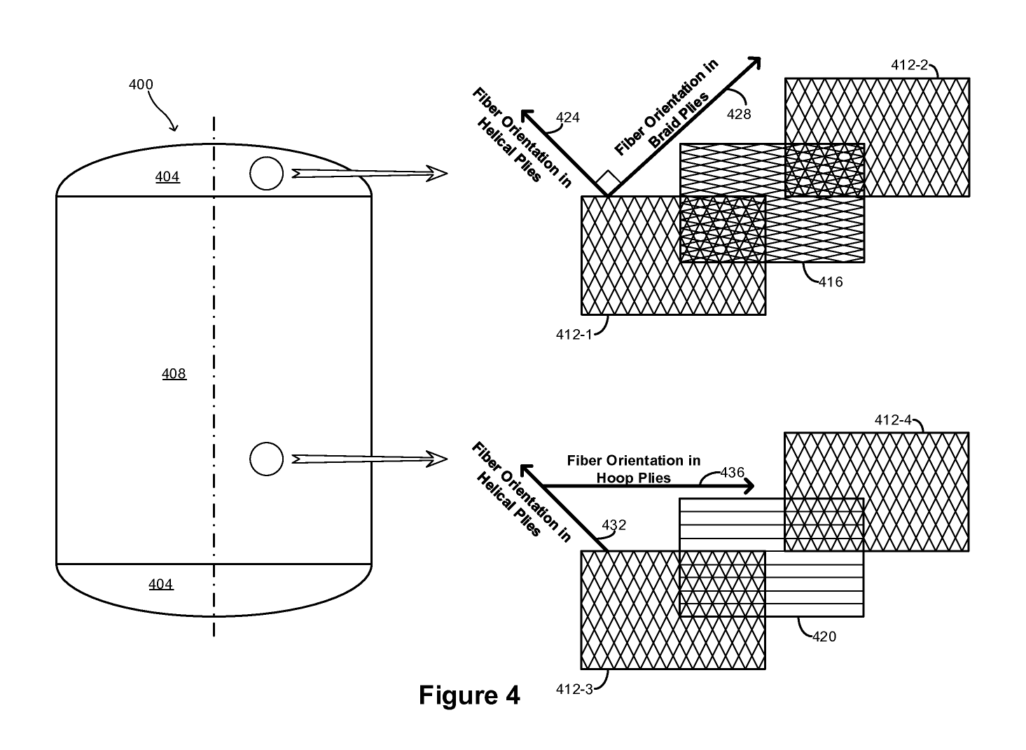

In some embodiments the fibers in a helical ply (or plies) may be low performance fibers relative to fibers within a hoop ply (or plies). In some embodiments, the fibers in an inner helical ply (or plies) may be low performance fibers compared with fibers in an inner hoop ply (or plies). Fibers within a hoop ply or plies may not have any variation or may consist of high performance plies in the inner layer and low performance plies in the outer layers. Hoop plies and/or helical plies are shown in FIG. 3A, FIG. 3B, and FIG. 4.

FIG. 3A shows the general structure of a cylindrical pressure vessel 300 with interspersed layers of circumferential hoop plies 308 and helical plies 304 according to some embodiments described herein. These plies may include various fibers such as, for example, carbon fibers and/or non-carbon fibers. The helical plies 304 may cross with any angle±φ. The composite laminate in the dome section may include only the helical plies 304.

FIG. 3B shows the hoop ply 308 sandwiched between two helical plies 304, allowing with plies having nearly orthogonal fiber orientation according to some embodiments described herein.

FIG. 4 shows a structure for a pressure vessel 400 in accordance with some embodiments. The pressure vessel 400 includes a cylindrical section 408 and at least one dome section 404. While it is generally expected that the cylindrical section 408 will have a right circular cross section, it is possible for other cross-sectional shapes to be used in other embodiments. For instance, elliptical cross sections might be used, particularly if the eccentricity of such an elliptical cross section is small. As used herein, the term “cylindrical” is thus not intended to be limited to right circular cross sections. The dome section 404 may also take on a variety of different forms in different embodiments, including hemispherical, semi-hemispherical, geodesic, and elliptical dome shapes, among others.

As the bottom portion of FIG. 4 illustrates, the presence of a hoop ply 420 sandwiched between helical plies 412 in the cylindrical section 408 causes there to be fiber orientations 432 and 436 that are inclined relative to each other. In some embodiments, effect is approximately mimicked in the dome section 404 by including such as, for example, a braid ply 416 in addition to the helical plies 412. Other embodiments may include only helical plies 412 in the dome section 404. The resulting fiber orientations 424 and 428 are shown in the illustration to be substantially orthogonal, although other orientations might result in specific configurations that are also effective at distributing stress. Note, the relative angles of the helical and braid plies in the dome region vary with longitudinal location in the dome.

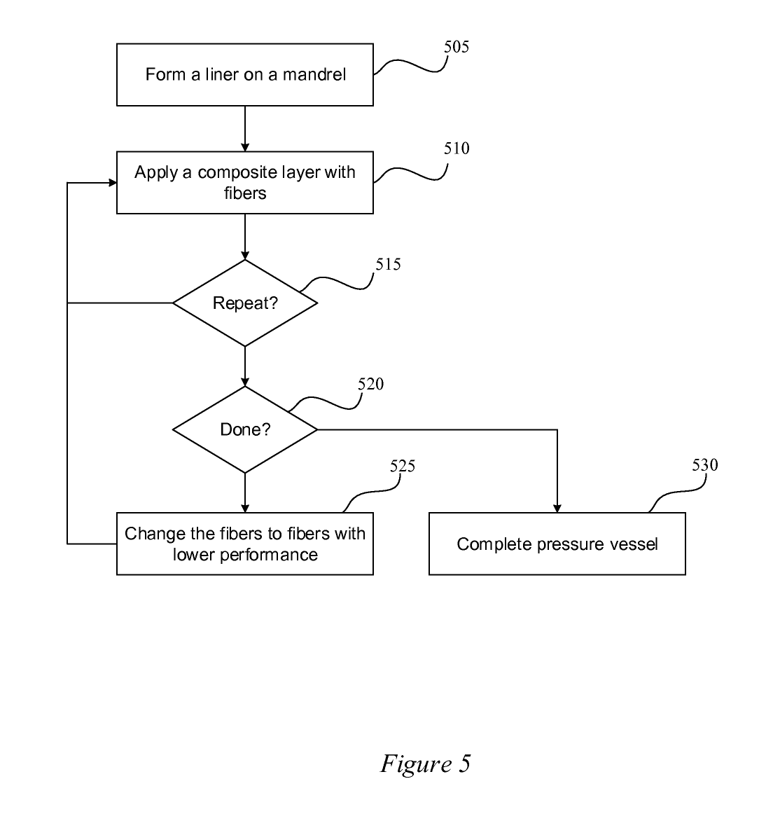

FIG. 5 is a flowchart of an example process for forming a composite pressure vessel according to some embodiments described herein. At block 505 a liner may be formed on a mandrel. The mandrel, for example, may have a shape that conforms to the desired shape of the pressure vessel. For example, the mandrel may have a cylindrical section and at least one domed section. Various other shapes and/or configurations of mandrels may be used without limitation.

In some embodiments, the mandrel may be dissolvable, collapsible, or some combination thereof.

In some embodiments, the liner may be a metal liner. In some embodiments, the liner may be coated with a primer, an overwrap, a jacket, or some combination thereof. The overwrap or the jacket may be constructed by superimposed and overlapping layers of resin impregnated filamentary materials, wrapped around the liner, with the interstices between the fibers or filament being filled by impregnating material such as hardenable epoxy resin that, upon setting and hardening, forms a matrix that firmly embeds such fibers or filamentary material. Various other liner layers may be used without limitation.

In some embodiments, block 505 may be skipped for pressure vessels that do not include a liner. Moreover, prior to block 505 various other steps or processes may occur.

At block 510 a composite layer may be formed on the mandrel. The composite layer may include a plurality of fibers. Block 510 may include various sub-processes such as winding fibers or plies on the liner or on other layers, applying various resins or epoxies, and/or various curing steps among others. In some embodiments, the fibers may be braided while being formed on the mandrel or braided prior to being formed on the mandrel.

In some embodiments, the composite material used to form the composite layer may be impregnated with resin or epoxy while being applied to the mandrel such as, for example, using a manual or semi-automated process in which an amount of resin is added to the top of the braid material and used to impregnate the braid with resin. In some embodiments, this may be accomplished with an automated or semi-automated process, such as, for example, through the use of resin-transfer molding (“RTM”), vacuum-assisted resin-transfer molding (“VARTM”) or centrifugal casting and an outer-surface mold that, in concert with the inner mandrel, define the finished dimensions of the braided barrier plies. The resin and the inner mandrel may be pressurized during this impregnation process to result in a part that comprises the braided or woven plies that has high dimensional tolerance and good thickness uniformity.

In some embodiments, a towpreg process may be used. In a towpreg process, a-preimpregnated fiber tow may be placed on the mandrel or on previously placed fibers.

In some embodiments, a winding machine may be used that includes the mandrel, one or more fiber cartridges (or spindles), and a fiber placement mechanism (automated fiber placement tool with x degrees of freedom, hand layed by a person, etc. The layup tool, for example, may place fiber from the fiber cartridge on the mandrel. In some embodiments, the layup tool may also impregnate the fiber with a resin or epoxy. In some embodiments, the layup tool may include one or more eyelets, heads, arms, or some combination thereof that may be used to direct the fiber from the cartridge onto the mandrel or other layers that have been layed up on the mandrel.

In some embodiments, the composite materials or fibers may be cut and/or premolded in to at least part of the shape of the mandrel.

At block 515, it can be determined whether to repeat block 510 with fibers having the same performance properties. If so, then the process returns to block 510. Otherwise the process proceeds to block 520. In some embodiments, it can be determined whether to repeat block 510 based on the amount of time spent at block 510. In some embodiments, it can be determined whether to repeat block 510 based on the amount of composite material used by weight, volume, or length.

At block 520 it can be determined whether the process is finished. For example, whether any more layers should be applied to the pressure vessel. If more layers should be applied, then the process proceeds to block 525. At block 525, the fibers are changed to fibers with a performance different than (e.g., lower than) the previously used fibers and the process may return to block 510 where a composite layer is applied with the different performance fibers. At block 525, the different performance fibers may be pulled from a different cartridge or spindle than the high performance fibers.

If, at block 520, it is determined that the process is finished, then the process proceeds to block 530 where the pressure vessel is completed. Block 530 may include any number of sub-processes and/or steps that may be used to complete the pressure vessel. At block 530 the pressure vessel may be removed from the mandrel.

In some embodiments, blocks 510, 515, 520, and 525 may be repeated any number of times with fibers having different performance characteristics. In some embodiments, the performance characteristics of the fibers that are changed in block 525 may be reduced during each successive iteration.

Process 500 may include one or more cure cycles where the pressure vessel, layers, fibers, resins, etc. are heated to a temperature (e.g., above 350 degrees Fahrenheit) until, for example, any resin is crosslinked and cured creating a solid resin/fiber vessel.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A pressure vessel comprising:
a first composite layer surrounding an inner cavity and comprising a plurality of high performance fibers; and
a second composite layer disposed on the first composite layer and comprising a plurality low performance fibers,
wherein the plurality of high performance fibers have a strain greater than 2.0% and the plurality of low performance fibers have a strain less than 2.0%.

2. The pressure vessel according to claim 1, wherein the plurality of low performance fibers comprises a textile-PAN precursor fiber or a polyolefin precursor fiber.

3. The pressure vessel according to claim 1, wherein the pressure vessel is capable of storing gases or liquids at pressures above 700 bar.

4. The pressure vessel according to claim 1, wherein the plurality of high performance fibers comprises more than 50% of a total amount of fibers comprising the plurality of high performance fibers and the plurality of low performance fibers.

5. A pressure vessel comprising:
a first composite layer surrounding an inner cavity and comprising a plurality of high performance fibers; and
a second composite layer disposed on the first composite layer and comprising a plurality low performance fibers,
wherein the plurality low performance fibers comprise fibers that are different than the plurality of high performance fibers, and wherein the plurality of low performance fibers have at least one measurable characteristic that is less than at least one measurable characteristic of the plurality of high performance fibers.

6. The pressure vessel according to claim 5, wherein the plurality of high performance fibers have a longitudinal strain between 0.8% and 2.0%, and the plurality of low performance fibers have a longitudinal strain less than the high performance fibers.

7. The pressure vessel according to claim 5, wherein the plurality of low performance fibers comprises a textile-PAN precursor fiber or a polyolefin precursor fiber.

8. The pressure vessel according to claim 5, wherein the pressure vessel is capable of storing gases or liquids at pressures above 700 bar.

9. The pressure vessel according to claim 5, wherein the plurality of high performance fibers comprises more than 50% of a total amount of fibers comprising the plurality of high performance fibers and the plurality of low performance fibers.

10. The pressure vessel according to claim 5, wherein the plurality of high performance fibers have a strain greater than 2.0% and the plurality of low performance fibers have a strain less than 2.0%.

11. The pressure vessel according to claim 5, wherein the plurality of high performance fibers comprise hoop plies and the plurality of low performance fibers comprise helical plies.

12. The pressure vessel according to claim 5, wherein the first composite layer comprises a plurality of low performance fibers.

13. The pressure vessel according to claim 5, wherein the second composite layer comprises a plurality of high performance fibers.

14. The pressure vessel according to claim 5, further comprising a third composite layer disposed on the second composite layer and comprising a third plurality of fibers, wherein the third plurality of fibers comprise fibers that are different than the plurality of low performance fibers, and wherein the third plurality of fibers have at least one measurable characteristic that is less than at least one measurable characteristic of the plurality of low performance fibers.

15. A method comprising:
forming a vessel liner on a mandrel;
applying a plurality of high performance fibers on the vessel liner; and
applying a plurality of low performance fibers on the plurality of high performance fibers, wherein the plurality of low performance fibers comprise fibers that are different than the plurality of high performance fibers, and wherein the plurality of low performance fibers have at least one measurable characteristic that is less than at least one measurable characteristic of the plurality of high performance fibers.

16. The method according to claim 15, wherein the plurality of high performance fibers have a longitudinal strain between 0.8% and 2.0%, and the plurality of low performance fibers have a longitudinal strain less than the high performance fibers.

17. The method according to claim 15, wherein the plurality low performance fibers comprises a textile-PAN precursor fiber or a polyolefin precursor fiber.

18. The method according to claim 15, wherein the plurality of high performance fibers comprises more than 50% of a total amount of fibers comprising the plurality of high performance fibers and the plurality of low performance fibers.

19. The method according to claim 15, wherein the plurality of high performance fibers have a strain greater than 2.0% and the plurality of low performance fibers have a strain less than 2.0%.

20. The method according to claim 15, wherein at least a subset of the plurality of high performance fibers are applied as hoop plies and at least a subset of the plurality of low performance fibers are applied as helical plies.
